(19) United States
(12) Patent Application Publication
(10) Pub. No.: US 2025/0308238 A1
(43) Pub. Date: Oct. 2, 2025

(54) GENERALIZED EVENT CAMERA

(71) Applicant: Wisconsin Alumni Research Foundation, Madison, WI (US)

(72) Inventors: Mohit Gupta, Madison, WI (US); Matthew Dutson, Madison, WI (US); Varun Sundar, Madison, WI (US)

(21) Appl. No.: 18/623,989

(22) Filed: Apr. 1, 2024

(51) Int. Cl. G06V 20/40; G06V 10/60

(52) U.S. Cl. CPC G06V 20/44; G06V 10/60

(57) ABSTRACT

Methods and systems for detecting changes via an event camera are disclosed. The methods and systems include: monitoring a plurality of pixel measurements from an image sensor, determining an estimate of intensity for a scene using a current frame; detecting changes of the plurality of pixel measurements using the estimate of intensity for the scene; maintaining a stored flux value for each of a first plurality of pixels, wherein the first plurality pixels have not changed intensities; transmitting change information for each of a second plurality of pixels, wherein the second plurality of pixels have changed intensities; determining if a change in the scene has occurred based on the change information for each of the second plurality of pixels; triggering an event in response to the change in the scene; and rendering an event camera image. Other aspects, embodiments, and features are also claimed and described.

### STATEMENT OF GOVERNMENT SUPPORT

This invention was made with government support under 2107060 awarded by the National Science Foundation. The government has certain rights in the invention.

### CROSS-REFERENCE TO RELATED APPLICATION(S)

N/A

### TECHNICAL FIELD

The systems, methods, embodiments, and novel concepts discussed herein relate generally to processing of data obtained by cameras and other similar sensors. Certain embodiments may achieve distinctly improved imaging capabilities in real time utilizing ‘event camera’ style timing information and image intensity information.

### BACKGROUND

In the field of imaging, event cameras are a class of camera that can utilize a high frame rate to selectively output information relating to scene changes. In other words, event cameras can be used to capture high-precision timing information at a parsimonious readout rate and low latency. However, event cameras do not retain sufficient information to support arbitrary downstream algorithms, such as image reconstruction, given that event cameras generally attempt to capture only changes in a scene, but not all information about a scene. For example, event cameras may only encode changes in per-pixel brightness, so as to output an indication of movement or scene change, but generally do not read or preserve sufficient scene information to support a wide variety of downstream tasks such as full image reconstruction or video.

Due to the fact that event cameras do not generally preserve scene/image information (but rather focus on change detection), post-acquisition algorithms usually need to be employed so that the “events” detected by an event camera are supplemented with conventional intensity/optical frames. This approach presents hardware complexity, requires acquisitions from more than one sensor, and can result in spatial and temporal misalignment, and/or a mismatch in image formation models.

Therefore, it would be desirable to have an improved system for capturing the high-speed “event” information common to event cameras while also allowing for image reconstruction, without having the foregoing disadvantages. Thus, the present disclosure provides various systems and methods that improve on the existing field in two ways: how an “event”-style camera accumulates and preserves intensity information, and when/how an event is transmitted, which may allow cameras to exhibit both high-speeds and high-fidelity imaging at low readout rates.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure can provide a method for detecting changes via an event camera. A plurality of measurements from an image sensor with a high frame rate can be monitored. An estimate of intensity for a scene using a current frame can be determined. Changes of the plurality of pixel measurements can be detected using the estimate of intensity for the scene. A plurality of stored flux values can be maintained for each of a first plurality of pixels. The first plurality of pixels may not have changed intensities. Change information can be transmitted for each of a second plurality of pixels. The second plurality of pixels may have changed intensities. It can be determined it a change in the scene has occurred based on the change information for each of the second plurality of pixels.

In other aspects, the present disclosure can provide a system for detecting changes. The system can include an image sensor and a processor electrically coupled to the image sensor. The processor can be programmed to monitor a plurality of pixel measurements from the image sensor. The processor can determine an estimate of intensity for a scene using a current frame. The processor can detect changes of the plurality of pixel measurements using the estimate of intensity for the scene. The processor can maintain a stored flux value for each of a plurality of pixels. The first plurality of pixels may have not changed intensities. The processor can transmit an intensity change for each of a second plurality of pixels. The second plurality of pixels may have not changed intensities. The processor can determine if a change in the scene has occurred based on the intensity change value for each of the second plurality of pixels. The processor can trigger an event in response to the change in the scene.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a flow diagram illustrating an example process for analyzing varying types of images according to some embodiments.

FIG. 2 is a flow diagram illustrating an example exponential moving average process according to some embodiments.

FIG. 3 is a flow diagram illustrating an example Bayesian change detector process according to some embodiments.

FIG. 4 is a flow diagram illustrating an example spatiotemporal chunk process according to some embodiments.

FIG. 5 is a flow diagram illustrating an example coded-exposure process according to some embodiments.

FIG. 6 is a block diagram conceptually illustrating a system for analyzing pixel data according to some embodiments.

FIG. 7 is a block diagram conceptually illustrating a device for processing frames of scene information as a generalized event camera, according to some embodiments.

FIG. 8 illustrates various event camera outputs, according to some embodiments.

FIG. 9 illustrates four frames illustrating a processes for summing events generated by a jack-in-the-box, according to some embodiments.

FIG. 10 illustrates three frames corresponding to changes detected by an adaptive-EMA and adaptive-Bayesian event camera, according to some embodiments.

FIG. 11 is an example process for transforming a spatiotemporal chunk, according to some embodiments.

FIG. 12 illustrates six high-speed videography frames of a stress ball thrown at a coffee mug, according to some embodiments.

FIG. 13 illustrates ten nighttime frame examples taken using various event imaging processes, according to some embodiments.

FIG. 14 illustrates twelve event frame examples taken by various event imaging processes, according to some embodiments.

FIG. 15 is a graph illustrates rate-distortion evaluation results, according to some embodiments.

FIG. 16 illustrates two graphs with on-chip compatibility data, according to some embodiments.

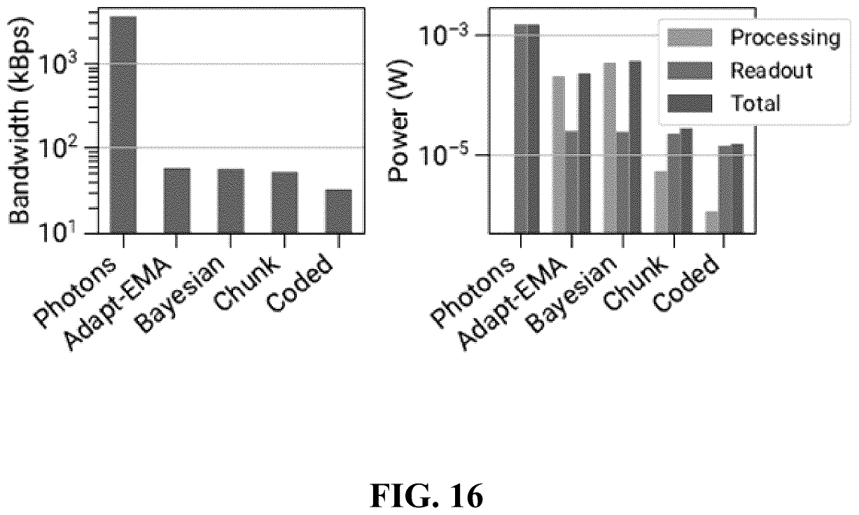

### DETAILED DESCRIPTION

The detailed description set forth below in connection with the appended drawings is intended as a description of several possible configurations, but is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without some or all of these specific details. In some instances, well-known structures and components are shown in block diagram form to avoid obscuring such concepts. Likewise, while certain advantages of the systems and methods described herein are highlighted, it should be recognized that additional advantages may flow from use of these systems and methods even though not stated herein.

### Methods and Techniques

The disclosure herein describes various ways to overcome the limitations of existing event-camera systems (and related systems), in that embodiments of the present disclosure can allow for capture of a form of precise detection of changes in a stream of image frames that replicates what a typical event camera can achieve while simultaneously storing scene information such that the event information and scene information can be combined for a variety of beneficial uses. For example, a stream of frames can be processed according to the techniques herein to detect when changes of interest occur and generate images showing the scene as relates to the detected changes. Thus, not all frames of a high-speed acquisition stream need be stored or reconstructed into images, but where images are reconstructed to reflect detected “events,” information relevant for a user or downstream process is still preserved. Thus, the techniques described herein maintain the low readout/resource demand of event cameras while still preserving relevant scene information as a typical optical/image camera would.

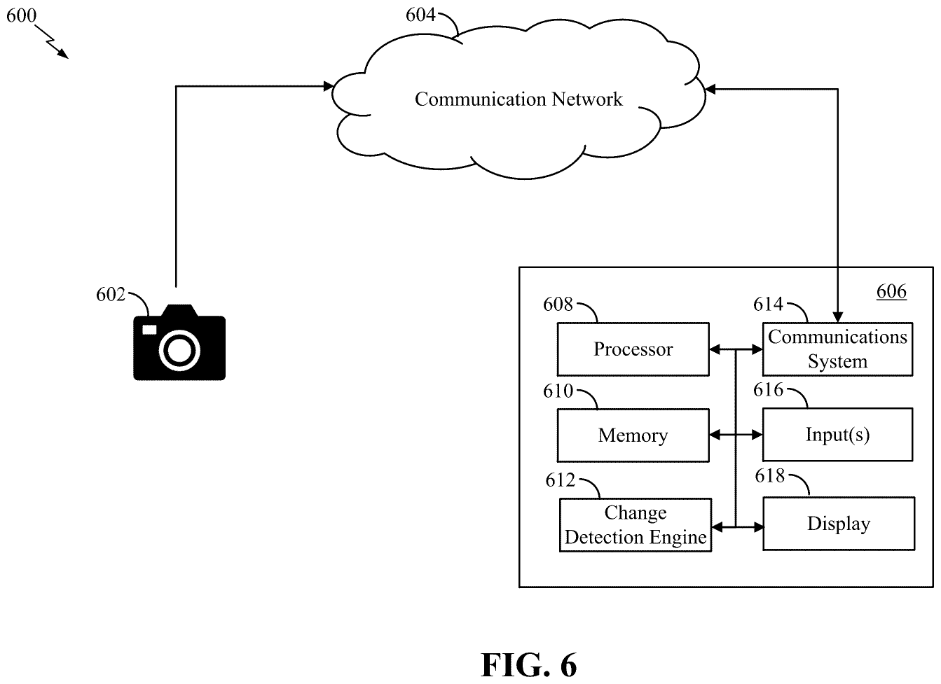

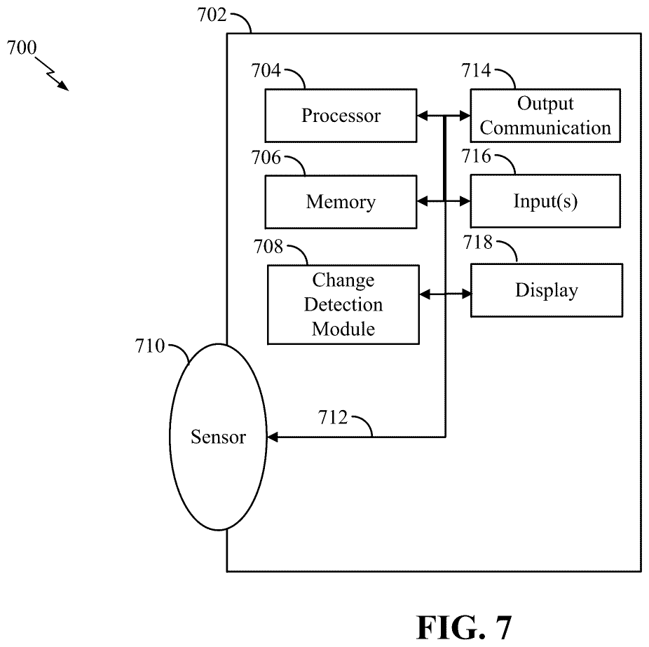

These techniques can be implemented via a variety of specialized types of hardware; several example systems are described below in reference to FIGS. 6 and 7. However, for context in understanding the underlying methods described herein that enable the foregoing advantages, a few attributes of such specialized hardware will first be described.

Typical event cameras (sometimes called neuromorphic cameras or dynamic vision sensors) capture changes in a scene, rather than capture image frames at fixed intervals. However, in order for them to perform in a precise manner to detect changes in useful scenes (e.g., rapid motion and/or varying lighting conditions), they generally will have a high rate of data acquisition. While event cameras are not usually described in terms of a frame rate or fps, they do have an extremely high temporal resolution, often microsecond precision. Yet, their output is highly dependent upon the scene: a complete static scene being viewed by an event camera will result in no output. A scene with rapid lighting changes or rapid movement could have a very high rate of “events” being output.

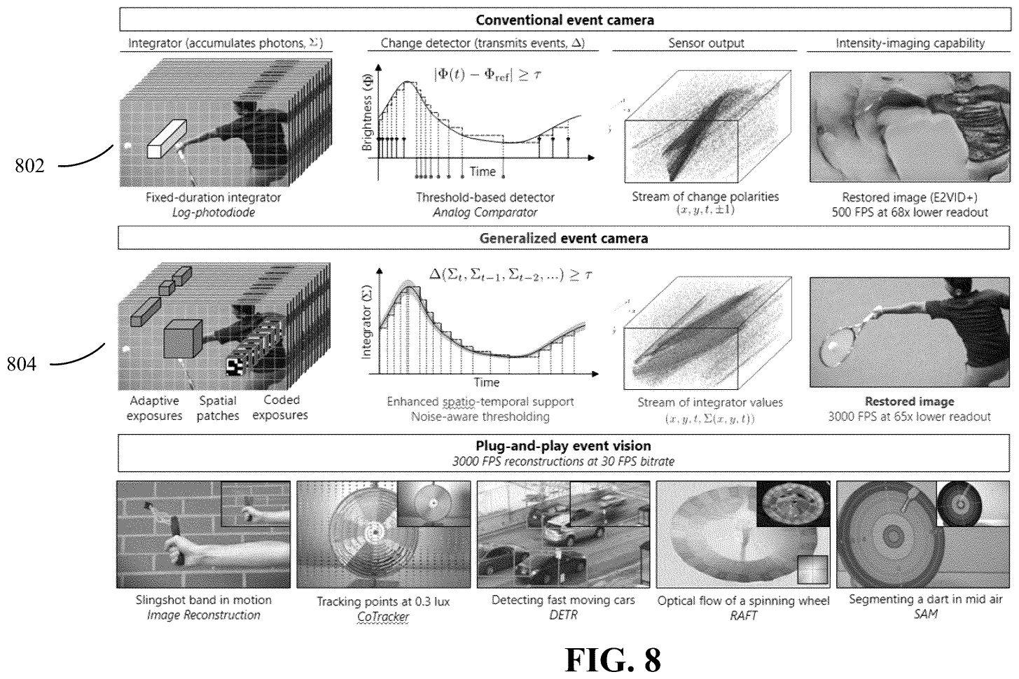

Thus, traditionally, an ‘event camera’ would be understood to transmit information selectively, in response to change in scene content. The top panel 802 of FIG. 8 provides conceptual information regarding what a typical event camera detects, and what an image would like look if it were to be reconstructed from event camera information. More specifically, panel 802 shows a high level depiction of operation of a conventional event camera, comprising an integration, change detection, sensor output, and image output. This ‘selective’ output characteristic allows event cameras to encode high-precision timing information without proportionately high readout, unlike frame-based cameras where readout occurs at fixed intervals. In event cameras, an event is ‘triggered’ (e.g., determined or detected) whenever a pixel measures a substantial changes in incident flux, i.e.,

$$\vert Φ ( x , t ) - {Φ}_{r e f} ( x ) \vert \geq τ \qquad Equation ( 1 )$$

where Φ(x, t) is a noisy flux estimate at pixel location x and time t, and t is the contrast threshold. Φ_{ref}(x) is a previously-recorded reference, set to Φ(x, t) whenever an event is triggered. An event is represented by a packet that encodes the polarity of observed change, such as:

$$( x , t , sign ( Φ ( x , t ) - {Φ}_{ref} ( x ) ) ) \qquad Equation ( 2 )$$

Event polarities, although adequate for some applications, do not retain sufficient intensity information to support a general set of computer vision tasks. 1-bit polarities are inherent to the photodiode design of current event cameras. In other words, the fundamental mechanism of operation and/or hardware of traditional event cameras limit the information they capture in favor of acquiring and selectively outputting very precise temporal information indicating scene changes.

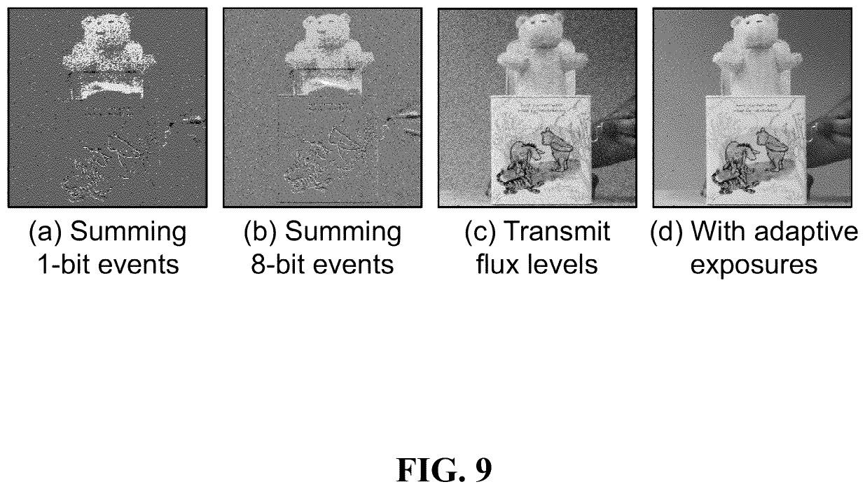

Precision of events may be increased, replacing the sign function in Eq. (2) with, e.g., 8-bit quantization. This modification reduces the quantization artifacts seen in FIG. 9(a), However, because events still encode changes, the intensity relative to an unknown initial offset (e.g., intensity change information) is all that is known. Most traditional cameras (e.g., optical or CMOS-based cameras) are able to capture far more information in each frame (i.e., each frame contains a full set of data indicative of a scene), but would not have a frame rate high enough to detect precise changes (the sensors in such cameras integrate over too long a time period in each frame, order to general rich image quality, and thus many “events” may have occurred during a given frame period). Even many high speed cameras could not achieve the temporal resolution generally expected for an “event camera” style detection.

However, some classes of cameras are able to at least acquire data rapid rapidly-enough to approximate the temporal resolution of event cameras. One such class of cameras is known as a single photon avalanche diode (SPAD) camera. SPAD cameras uses specialized sensors to detect extremely low quanta of light, down to individual photons. Their acquisition rates can be tens or hundreds of thousands of ‘frames’ (or integration cycles) per second. Other specialized high speed cameras can also reach tens of thousands of frames per second. For example, sensors known as quantitative CMOS (qCMOS) sensors such as those available from Hamatsu Photonics, quanta image sensors (QIS) such as those available from Gigajot Technology, and similar photon counting and/or high frame rate sensors may have similar abilities as SPAD sensors for purposes of some of the concepts disclosed herein. Yet, despite these devices having high frame rates, the ability to rapidly perform readout and processing necessary to allow for a real time change detection is not currently possible using ordinary means. However, the techniques described herein present an innovative way to harness the high frame rates of these cameras in a more efficient way so as to allow processing algorithms to perform change detection on their full image frame acquisitions in real time.

As will be described in more detail below, the boundary-condition issue of traditional event cameras can be resolved by transmitting intensity change information (e.g., flux levels or offset values indicative of the amount of change in a flux level) instead of merely an indication of a change, such that if a pixel triggers no events, its flux value is still preserved for use during the final readout. As illustrated in FIG. 9(c), this adjustment allows detail to be recovered in static regions. While such a modified sensor readout differs from conventional event cameras, the sensor retains a useful feature of event cameras: a high degree of temporal resolution in detection changes which can more practically be achieved through selective transmission based on scene dynamics.

With such an adapted sensor, it is to be expected that noise may still be seen in the recovered images (or may even impact event triggering itself). This noise arises from the stochastic natures of Φ(x, t). Ideally, Φ(x, t) averages over longer durations when there is less motion. To achieve this behavior a new integrator is introduced (e.g., a method for accumulating incident flux, as denoted by Σ). Specifically, an integrator Σ_{cuml}(x, t) that computes the cumulative flux since T₀ (the time of the last event) is proposed:

$${\sum }_{cuml} ( x , t ) = {\int }_{{T}_{0}}^{t} Φ ( x , s ) ds . \qquad Equation ( 3 )$$

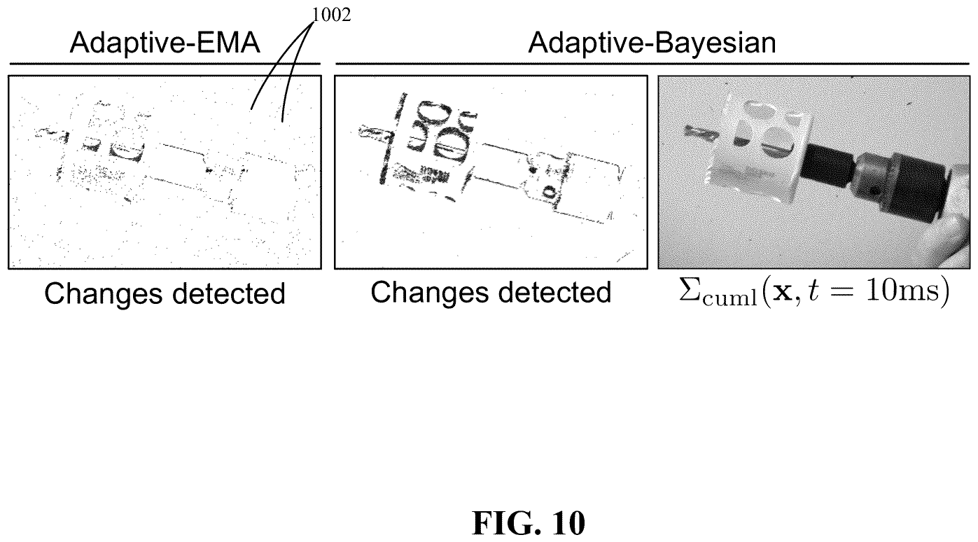

When an event is triggered at time T₁, the value of Σ_{cuml}(x, T₁) is communicated, which is interpreted as the intensity throughout [T₀, T₁]. This approach yields a piece-wise constant time series, with segments delimited by events. This can be thought of, therefore, as a form of adaptive exposures which are attained that conform to the scene dynamics: pixels or groups of pixels with rapid events have short exposures that better preserve motion; conversely, pixels with few events have long exposures with lower noise (as only the pixels that do not witness content changes have long exposure). FIG. 10(d) shows the significant noise reductions achieved with adaptive exposures.

The precision and usefulness of adaptive exposures can be influenced in some embodiments by the reliability of the change detector (e.g., the method used to trigger events, denoted by Δ). Current event cameras detect changes by applying a fixed threshold to measured intensity differences (Eq. (1)). This approach may not be reliable when Φ(x, t) is noisy.

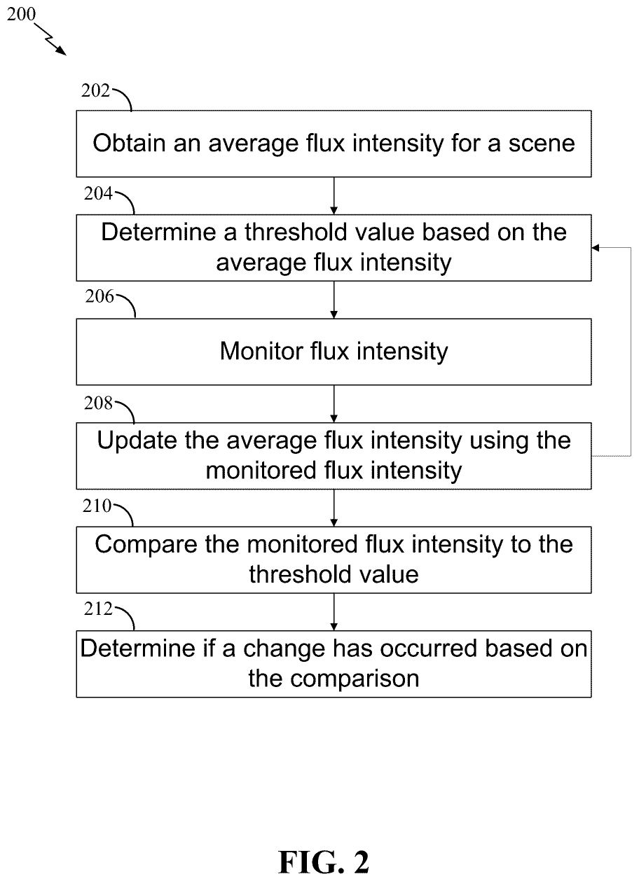

A more robust change detector may be designed, that leverages enhanced spatiotemporal context. This can be achieved by using temporal forecasters; by exploiting correlated changes in patches; or even by exploiting integrator's statistical properties. Descriptions below relative to FIGS. 2-5 provide further information on these various alternative approaches to change detector methods that can be used to enable efficient adaptive exposures. Further, the designs incorporate noise awareness, either explicitly (e.g., by tuning contrast thresholds) or implicitly, modulating the detector's behavior based on the stochasticity in Φ(x, t).

To implement these event camera designs, various types of imaging modalities may be utilized, which provides direct flux estimates Φ(x, t) or comparable fine detail information, at an extremely high time resolution. For example, an emerging class of single-photon sensors may be used in some examples: single-photon avalanche diodes (SPADs). SPADs can operate at extremely high speeds (˜100 kHz) without incurring per-frame read noise. Each Φ(x, t) measured by a SPAD array is limited only by the fundamental stochasticity associated with photon arrivals (shot noise). This can allow a single-photon device to provide high timing resolution without a substantial noise penalty.

Panel 804 of FIG. 8 depicts a conceptual representation of how an embodiment of a process according to the present disclosure can utilize the foregoing techniques to reconstruct an image, while still capturing event information. Specifically, panel 804 shows steps of adaptive exposure/spatial patches/coded exposures, then change detection in a spatio-temporal manner, an output showing a stream of integrator values, followed by a restored image.

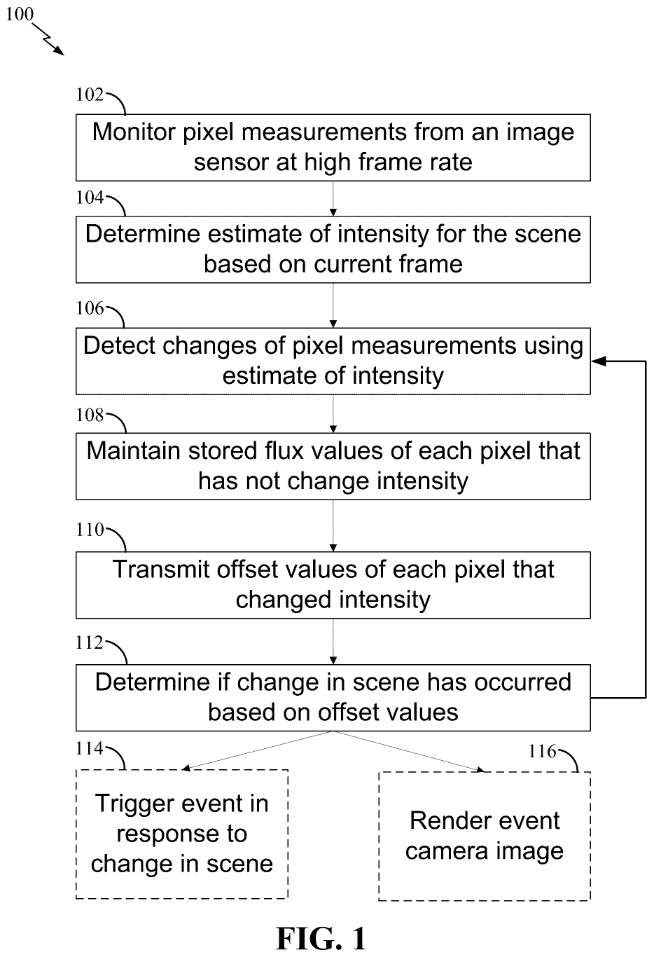

Referring now to FIG. 1, a generalized example method will be described for leveraging the high frame rate of a high speed camera (such as a SPAD camera) to perform change detection. FIG. 1 is a flow diagram illustrating an example process 100 for acquiring high speed image information and extracting even information while allowing for image reconstruction for any given frame in a real time sequence. As described below, a given implementation of such methods might omit some or all illustrated features/steps, may be implemented in some embodiments in a different order, and may not require some illustrated features to achieve certain advantages or improvements. In some examples, a system or device having specialized light sensors (e.g., in connection with FIG. 6 or FIG. 7) can be used to perform all or part of example process 100. However, it should be appreciated that other suitable hardware, sensors, and system architectures for carrying out the operations or features described below may perform process 100.

At step 102, the process 100 monitors pixel measurements obtained from an image sensor at a high frame rate. For example, pixel measurements may be obtained by decoupling a readout from a sensor array. Each “pixel” in the measured readout may correspond to a given sensor location within the sensor array. For example, the pixel measurements may be obtained using a SPAD sensor array used in a SPAD-based camera, or other high-speed camera sensors. While the output of different modalities of sensor may vary in format and content (e.g., some may contain color information, some may have higher pixel density/resolution, different frame rates, different formats for recording relative intensities of light incidence, etc.), for purposes of the type of process described in FIG. 1 pixel measurements can be generalized so as to be thought of as including an incident flux, Φ(x, t) at a pixel location x and time t. Accordingly, references below to SPAD sensors should be understood to include the various other types of photon-counting and/or high frame rate image sensors of comparable capabilities as SPAD sensors for purposes of the concepts disclosed herein.

At step 104, the process 100 determines an estimate of intensity of the current scene being viewed by the image sensor. In some examples, intensity information may be determined using the pixel measurements which may be encoded for each time step or frame of the camera. For example, some sensors may encode intensity as the output of a sensor integrating light detection over a period; others may encode intensity by color or relative intensity modified by camera settings. However, generally speaking the intensity information for the current scene may change based on the scene's dynamics, though in many instances not all pixels of an image sensor may output a different intensity from frame to frame even if changes are occurring elsewhere in the scene.

Thus, rather than storing actual intensity information for every frame of an acquisition or stream of frames, process 100 stores a running estimate of intensity. At the start of an acquisition, the running estimate of intensity may simply be the actual intensity values at each pixel, or may be an average intensity for a few initial acquisition frames. These values are stored in a memory (e.g., a register, on-board memory, on-chip memory, etc.) that can readily be updated after each frame or at another desired periodicity while frame data is continuing to arrive from a sensor in real time (or subsequent frames are being processed of a given prior acquisition).

At step 106, the process 100 analyzes a current frame n to detect any changes in the current frame's intensity measurements versus the corresponding values in the stored estimates of the intensity of the current scene. As described below, the determination of changes may be on a per-pixel basis, by patches or clusters of pixels, or by frames in the aggregate. The degree of difference between intensity values to constitute a “change” may be thresholded or may be per various statistical techniques as described below. In many instances a change may occur in one or more pixels which makes up a portion of the current scene. In some embodiments, a change may be triggered whenever a pixel measures a change in incident flux. In other embodiments, various algorithms may be utilized to differentiate noise in the incident flux readout from actual scene changes. In alternative embodiments, the process 100 may analyze frame n for differences as against the prior frame, n-1, or against a moving average of a window of prior frames (e.g., a moving average of n-1, n-2, n-3, or other similar groupings), rather than against the stored estimates.

At step 108, the process 100 transmits flux values of each pixel that has not changed intensity. The pixels that have not changed intensities can include each pixel for which a change was not detected by step 106. Where it is determined that the incident flux values of each such pixel are not different from the stored estimated value corresponding to the pixel, the actual flux values for such pixels at frame n may be simply discarded. In some embodiments, the flux values of frame n may be stored for possible future use in a final readout of the values in order to recover detail in static regions. In other embodiments, the actual flux value of a given pixel that has not changed may be stored at a given periodicity (e.g., every 10^{th} unchanged frame, or every 100^{th}, etc.) to provide for more detail in a final rendered image corresponding to an associated change.

For all pixels that were not determined to have exhibited a relevant change, their corresponding stored values of estimated intensity are not adjusted.

At step 110, the process 100 transmits change information for pixels that have been determined to have changed intensity in a way that reflects a relevant scene change (e.g., not merely noise). The change information can include an intensity change value such as an offset value or other data construct that indicates how much detected intensity of a given pixel has changed with respect to the corresponding stored estimated intensity of step 102 for that pixel (or groups of pixels). In some embodiments, the change information may also encode a time, t, or a frame, n. Conveying change information such as offset levels, rather than actual intensity values, may permit a beneficial retention of relative scene intensities, especially for pixels that may change often relative to static pixels. In other embodiments, however, full or actual measured values of intensities for changed pixels may be transmitted. For example, when a change has been detected, rather than calculate the amount of offset, process 100 could simply convey the actual intensity value, to replace or supplement the existing estimate of intensity value.

The change information (which may include an intensity change value such as an offset value or an actual intensity value) may be transmitted to the memory storing the estimates of intensity value. In some embodiments, the stored intensity values in such memory are adjusted (increased or decreased) or replaced according to the change information. In other embodiments, some or all change information may be stored in the memory in addition to the existing estimated intensity value or in addition to the updated intensity value.

At step 112, the process 100 determines if a material scene-level change has occurred in the current scene, based on the change information. In some examples, a change in the current scene may be determined if changes in pixel measurements indicate one or more dynamic regions in the scenes. A change in the scene may include dynamic events in which the scene content changes indicate motion. In other examples, a change may include dynamic changes in lighting.

At step 114, the process 100 may optionally flag that an ‘event’ has occurred in response to a determined change in the scene. In some embodiments, this information may be utilized to formulate an output that parallels what a dedicated or typical event camera might output. In other examples, an alarm or notification may be triggered when a change in the scene is determined. Alternatively, or in combination with step 114, the process 100 may optionally render an image at step 116 that depicts or corresponds to the change. The image may be reconstructed from the frame n at which an event was determined to have occurred. However, in other embodiments where full frame data is not stored for each given frame, the image may be reconstructed from some or all of the values of the stored estimates of pixel intensity. In this manner, a substantial savings in memory need, processing demand and readout time can be achieved because no frames are being individually stored, or not every frame is being individually stored, and yet an image can be fully reconstructed to correspond to any point in time t or any given frame n of an acquisition or at any arbitrary point in an ongoing stream of frames.

Thus, various techniques may be used to generate image(s) or video from the same sensor that was also capturing event information, in real time or near real time as the image information is being captured by a camera or sensor. In some examples, the rendered image may be transmitted over a communication network to a remote device. In some examples, the event may include displaying an image and/or video which may highlight or indicate the region of change.

Next various specific methods for performing change detection will be described, which can enable or supplement process 100. Each of these change detection processes may be used alone, in combination with, in parallel with, or as alternatives to one another (e.g., whether dictated by predetermined settings, user selection, or dynamically selected for a given exposure or task to take into account resource constraints or scene information).

FIG. 2 is a flow diagram illustrating an example of a moving average-based change detection process 200 according to some embodiments. The process 200 may occur during step 106 of process 100, in which changes in pixel intensity measurements are detected. At step 202, the process 200 obtains an average flux intensity for a scene. The average flux intensity for a scene may be obtained using the estimate of intensity for a scene, determined in step 104 of process 100. For example, at step 202, the process 200 may average the flux intensities obtained using a SPAD array or portion thereof. The average flux intensity for a scene may be an adaptive cumulative exposure, rather than of a single-bit change polarity.

At step 204, the process 200 determines a threshold value based on the average flux intensity. The threshold value may reflect the flux intensity for a scene, averaged over time. In some examples, the threshold may randomly vary in contrast based on a uniform sampling rate within a specified range in order explicitly incorporate noise awareness. In other examples, the threshold value may remain fixed. In other embodiments, a dynamic threshold or relative threshold may be applied so that the more a scene changes (e.g., rapid movement of objects in scene), the finer the threshold value may be, and the more a scene remains static for long periods of time (e.g., security cameras) the higher the threshold may be. Similarly, in situations such as low light/low noise scenes, a threshold may be lowered, while in very bright scenes (where a high degree of ambient light is present), a higher threshold may be utilized or a threshold may be required to be met for a given number of frames before a “change” is determined.

At step 206, the process 200 monitors the flux intensity of the scene being captured. The flux intensity can include specific measurements of one or more pixels in a scene, such as incident flux. In some examples, the flux intensity may be monitored from the output of a single photon sensor (e.g., a SPAD sensor), which indicates both the flux intensity and corresponding pixel location at a discrete time. At step 208, the process 200 updates the average flux intensity using the monitored flux intensity. For example, any values associated with the monitored flux intensity may cause the average flux intensity to change. Utilizing a moving average may prevent any changes in the scene not associated with an event to occur without indicating the detection of an event (e.g., changes in lighting, background noise, etc.).

At step 210, the process 200 compares the monitored flux intensity to the threshold value. Any flux intensity values which fall within the threshold may indicate that no change in the scene has occurred. In contrast, flux intensity values which fall outside of the threshold value may indicate a change. At step 212, the process 200 determines if a change has occurred based on the comparison. If a change has occurred, the process may trigger and event or render an event camera image, as described in steps 114 and 116 of process 100.

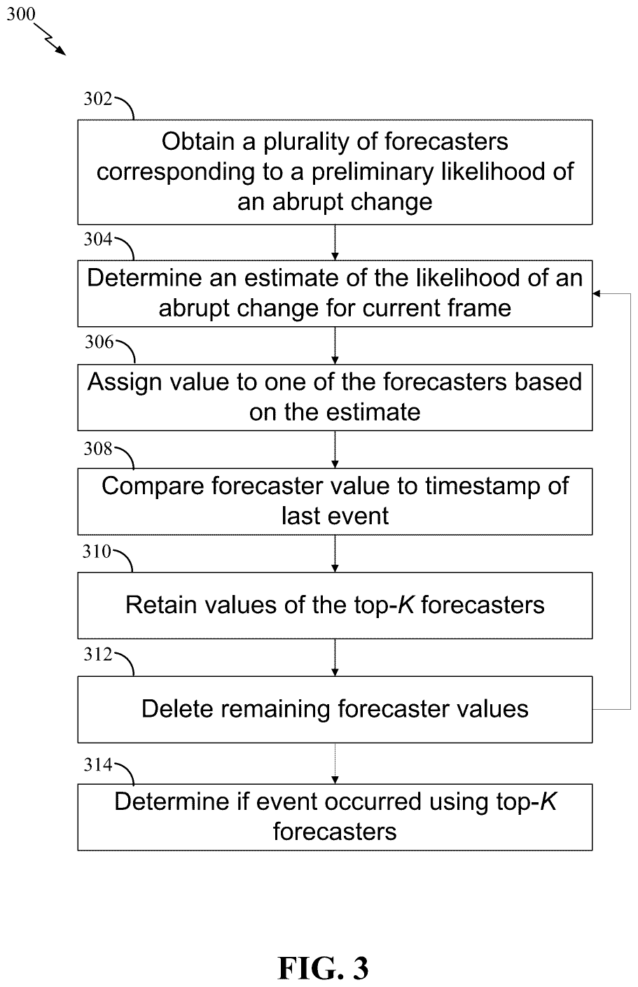

FIG. 3 is a flow diagram illustrating an example Bayesian change detector process 300 according to some embodiments. The process 300 may occur during step 106 of process 100, in which changes in pixel measurements are detected using an estimate of intensity. Process 300 may be used in addition to (e.g., in parallel with) or as an alternative to process 200. Process 300 may use a Bayesian change detector to detect per-pixel changes associated with an event. This process may allow trigger to events occurring in a scene, while filtering out stochastic variations caused by photon noise.

At step 302, the process 300 obtains a plurality of forecasters corresponding to a preliminary likelihood of an abrupt change. A forecaster can be a value that indicates the likelihood of the abrupt change occurring for a given scene. Examples of the calculation of forecasters are described below.

At step 304, the process 300 determines an estimate of the likelihood of an abrupt change for a current frame. The estimate of the likelihood of an abrupt change may be determined using formulation attuned to the stochasticity in incident flux for a given scene.

At step 306, the process 300 assigns a value to one of the forecasters based on the determined estimate. In some examples, there may be a forecaster for each time step. Moreover, at each time step, a new forecaster value may be initialized as a recurrence of previous forecasters, and existing forecasters may be updated.

At step 308, the process 300 compares the forecaster value to a timestamp of the last event. This comparison may allow the process to detect any increases or changes in the likelihood of a change occurring. In some examples, the comparison occurs in a per-pixel basis of the scene.

At step 310, the process 300 retains the values of the top-K forecasters. For example, step 310 may use extreme pruning to only retain forecasters which indicate the highest likelihood of an abrupt change for the given scene. In some examples, only the three highest-values forecasters may be retained to adapt to memory-constrained scenarios.

At step 312, the process 300 deletes the remaining forecaster values. In some examples, the deletion of remaining forecaster values may comprise removing arrays within a memory and initializing space for a new forecaster.

Finally, at step 314, the process 300 determines if an event has occurred using the top-K forecasters. For example, an event may be triggered if the highest-value forecaster does not correspond to the timestamp of the last event.

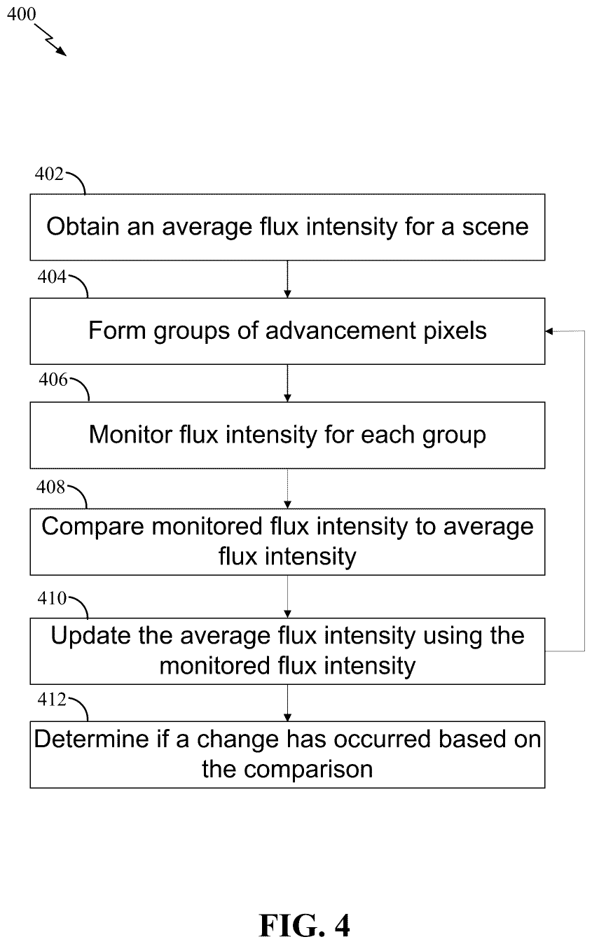

FIG. 4 is a flow diagram illustrating an example spatiotemporal chunk process 400 according to some embodiments. The process 400 may occur during step 106 of process 100, in which changes in pixel measurements are detected using an estimate of intensity. Process 400 may group together correlated, adjacent pixels to create small patches.

At step 402, the process 400 obtains an average flux intensity for a scene. The average flux intensity for a scene may be obtained using the estimate of intensity for a scene, determined in step 104 of process 100. For example, at step 402, the process 400 may average the flux intensities obtained using a SPAD. The average flux intensity for a scene may be an adaptive cumulative exposure, rather than of a single-bit change polarity.

At step 404, the process 400 forms groups of advancement pixels. Each group of advancement pixels may include a p×p patch of pixels, while p² pixels in the group. In some examples, one or more groups may be formed and may contain pixels from an entire scene, or a portion of a scene.

At step 406, the process 400 monitors the flux intensity for each group of pixels. The flux intensity can include specific measurements of one or more pixels in a scene, such as incident flux. In some examples, the flux intensity may be monitored from the output of a single photon sensor (e.g., a SPAD), which indicates both the flux intensity and corresponding pixel location at a discrete time

At step 408, the process 400 compares the monitored flux intensity to the average flux intensity. Flux intensity values which are not within range of the average flux intensity for a scene may indicate a change in the scene at the corresponding location of the group of advancement pixels.

At step 410, the process 400 updates the average flux intensity using the monitored flux intensity. For example, any values associated with the monitored flux intensity may cause the average flux intensity to change.

Finally, at step 412, the process 400 determines if a change has occurred based on the comparison. If a change has occurred, the process may trigger and event or render an event camera image, as described in steps 114 and 116 of process 100.

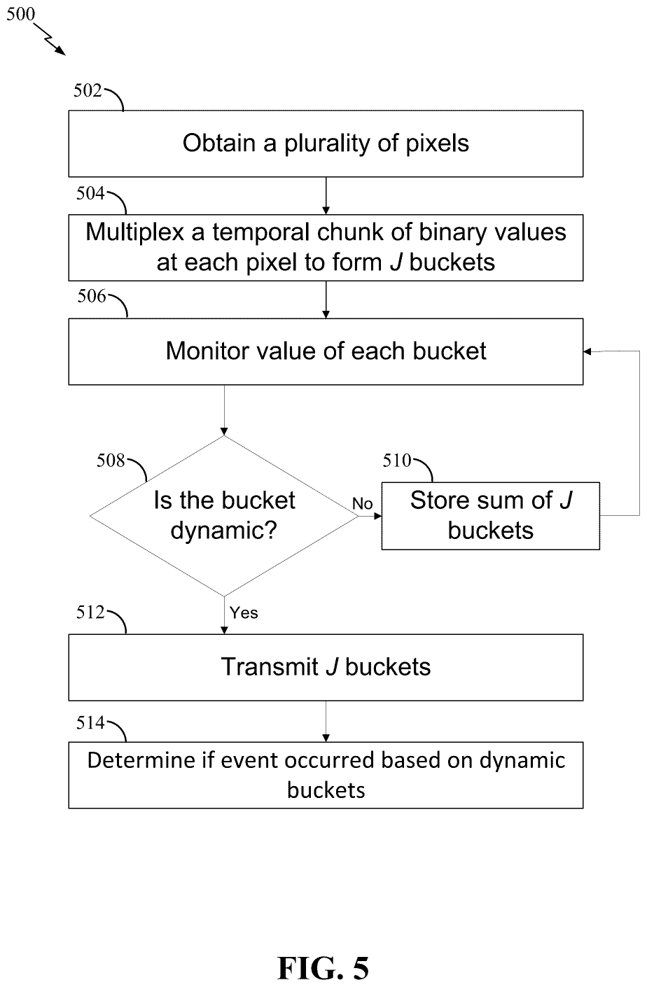

FIG. 5 is a flow diagram illustrating an example coded-exposure process 500 according to some embodiments. The process 500 may occur during step 106 of process 100, in which changes in pixel measurements are detected using an estimate of intensity. Process 500 may utilizes coded exposures to encode high-resolution timing information by multiplexing photon detections over long integration windows.

At step 502, the process 500 obtains a plurality of pixels. In some examples, the plurality of pixels may correspond to a patch of pixels from a portion of a scene. In other examples, the plurality of pixels may correspond to all pixels associated with a scene.

At step 504, the process 500 multiplexes a temporal chunk of binary values at each pixel to form J buckets. Buckets may comprise of coded exposures containing random binary mask sequences of length N. In some examples, 256-512 binary values may be used with a set of 2-6 non-overlapping binary codes for each bucket.

At step 506, the process 500 monitors the value of each bucket. In some examples, the value of each bucket may be monitored by exploiting the statistics of the coded exposures and sampling measurements associated with each J bucket.

At step 508, the process 500 determines if each bucket is dynamic. Buckets may be considered static when their associated measurements lie within a binomial confidence interval of one another. Buckets that do not have measurements that lie within the binomial confidence interval of one another may be considered dynamic.

If the bucket is not dynamic, the process 500 stores the sum of J buckets at step 510. For example, static buckets may store a long exposure, or the sum of the J buckets. In contrast, if the bucket is dynamic, the process 500 transmits J buckets at step 512. Moreover, any previously static intensity values encoded may also be transmitted when a bucket is dynamic. Finally, at step 514, the process 500 determines if an event has occurred based on the dynamic buckets.

### Example Hardware Systems

Certain techniques and advantages described herein can be achieved via a variety of different hardware configurations. For example, software instructions that operate on frame, or frame-like data, from a sensor could operate on a processor of the same device as the sensor, a locally connected device, or a remote resource. Thus, FIGS. 6 and 7 below provide general examples of possible configurations of hardware implementing aspects of the disclosure.

FIG. 6 shows a block diagram illustrating an example of a system 600 for analyzing pixel data of various image modalities, from a single image sensor device. In other words, the system 600 can substitute for the use of multiple different cameras or sensor modalities, while still providing the capability of achieving imaging as though there were multiple different modalities.

In some examples, a computing device 606 can obtain frame data from a sensor 602 (such as a camera) or other connected device via a communication network 604. In some examples, a frame (e.g., the first frame, the second frame, etc.) of frame data from sensor 602 can include an image, a video frame, a sensor bit plane (e.g., a SPAD bit plane), an event frame, a depth map (with/without an image), a point cloud, or any other suitable frame data or frame-like data (for ease of reference, the term “frame data” will in some instances be used to refer to all of such data types).

As depicted, the sensor 602 comprises a camera. As will be understood from the description herein, the sensor 602 may be a standalone sensor, or may be a variety of types of cameras. For example, sensor 602 may be a SPAD sensor of a SPAD camera, or may be a high-frame-rate optical/CMOS camera.

In some embodiments described herein, reference will be made to “photon data” and “SPAD sensors” for purposes of illustration. Sensors based on single photon avalanche diodes (SPADs) allow for extremely high frame rate detection SPAD arrays can operate as extremely high frame-rate photon detectors (e.g., ˜100 kHz or more), producing a temporal sequence of binary frames called a photon-cube. However, one of skill in the art will appreciate that alternative camera/sensor modalities exist that can also capture extremely high frame rates, such as multiple 1000s, tens of thousands, hundreds of thousands, or even millions of frames per second or more. The frame data captured by these cameras may be optical data, photon data, point clouds, depth data, or the like. The massive amounts of frame data offered by such sensors/cameras improve the ability of the techniques described herein to generate images that appear as though they were captured by a different camera/sensor (e.g., a capture by a SPAD sensor can be used to generate an image that appears as thought it was captured by a different type/modality of sensor, such as an event camera).

The computing device 606 can include a processor 608. In some embodiments, the processor 608 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), cloud resource, etc.

The computing device 606 can further include, or be connected to, a memory 610. The memory 610 can include or comprise any suitable storage device(s) that can be used to store suitable data (e.g., frame data, an image rendering model, etc.) and instructions that can be used, for example, by the processor 608. The memory may be a memory that is “onboard” the same device as the sensor that detects the frames, or may be a memory of a separate device connected to the computing device 606. Methods for processing frame data of sensor 602 for intensity estimation and change detection steps (as described above) may operate as its independent processes/modules, such as a separate change detection engine 612 that runs on the same processor 608 or a specialty processor (such as a GPU) that achieves greater efficiency in processing the frame data via change detection and intensity estimation operations, as described above. The memory 610 can include any suitable volatile memory, non-volatile memory, storage, or any suitable combination thereof. For example, memory 610 can include random access memory (RAM), read-only memory (ROM), electronically-erasable programmable read-only memory (EEPROM), one or more flash drives, one or more hard disks, one or more solid state drives, one or more optical drives, etc.

In further examples, computing device 606 can receive, transmit, and/or analyze information in real-time (e.g., receiving frame data from sensor 602, transmitting instructions to sensor 602, transmitting change information, or transmitting images or image data to remote devices, etc.) and/or any other suitable system over a communication network 604. In some examples, the communication network 604 can be any suitable communication network or combination of communication networks. For example, the communication network 604 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In one embodiment, communication network 604 can be a local area network, a wide area network, a public network (e.g., the Internet), a private or semi-private network (e.g., a corporate or university intranet), any other suitable type of network, or any suitable combination of networks. Communications links shown in FIG. 6 can each be any suitable communications link or combination of communications links, such as wired links, fiber optic links, Wi-Fi links, Bluetooth links, cellular links, etc.

In further examples, computing device 606 can further include a display 618 and/or one or more inputs 616. In one embodiment, the display 618 can include any suitable display devices, such as a computer monitor, a touchscreen, a television, an infotainment screen, etc. to display the report. In further embodiments, and/or the inputs 616 can include any suitable input devices (e.g., a keyboard, a mouse, a touchscreen, a microphone, etc.). In yet further embodiments, the sensor 602 may be a camera that exports frame data in real-time to a remote resource which performs change detection and other processes as described herein, then receives reconstructed images or event trigger information from the resource. In such an instance the display 618 and inputs 616 may be part of the sensor 602.

Referring now to FIG. 7, an example of an alternative configuration is shown, in which the processor that determines if a change in a scene has occurred is located in the same device as the sensor that captures the frame data. FIG. 7 shows a block diagram illustrating an example 700 of systems/devices for processing frames of scene information as a generalized event camera, per the techniques described herein. The integrated device 702 thus includes a processor 704 that is a part of the device. As discussed above, the processor 704 can be any suitable hardware processor or combination of processors. The processor 704 can be adapted to process frame data obtained from a sensor 710 using generalized event camera methods via change detector module 708. In some embodiments, the change detector module 708 may comprise an on-board processing resource that is designed to be application-specific, in that it efficiently performs one or more of the change detection and related steps of a method such as described with respect to FIG. 1. The integrated device 702 can further include a memory 706. The memory 706 can include any suitable storage device(s) that can be used to store suitable data (e.g., frame data, a machine learning model, pixel information, etc.) and instructions that can be used, for example, by the processor 704. In FIG. 7, the memory may be a memory that is “onboard” the same device as the sensor that detects the frame data. The memory 706 can include any suitable volatile memory, non-volatile memory, storage, or any suitable combination thereof, as described above. The memory and the processor may be connected via an internal bus or similar connection 712 that allows for processing of frame data without having to format the data for off-device transfer, which can be relatively slow compared to the frame rate of high-frame-rate cameras such as SPAD-based cameras.

In further examples, the integrated device 702 can further include a display 718 and/or one or more inputs 716. The display 718 can include any suitable display devices, such as a small LCD or LED screen, a touchscreen, or separate display screen connected to the camera. The inputs 716 of the device can include any suitable input devices (e.g., buttons, switches, a touchscreen, a microphone, etc.).

### Example Embodiments and Experimental Findings

‘Intensity Preserving’ and ‘Generalized’ Event Cameras: A SPAD array can operate as a high-speed photon detector, producing binary frames as output. Each binary value indicates whether at least one photon was detected during an exposure. The SPAD output response, Φ(x, t), can be modeled as Bernoulli random variable, with P(Φ(x, t)=1)=1−e^{-(ηN(x,t)+d)} (4), where N (x, t) is the number of incident photons during an exposure, n is the photon detection efficiency, and d represents the dark count rate. The inherently digital SPAD response allows the software-defined transformations to be computed on the signal Φ(x, t), including operations that may be nontrivial to realize in analog photodiode circuits. Being software-defined, these Φ(x, t) transformations can be readily reconfigured, allowed a variety of single-photon (Σ-Δ) event cameras to be designed.

By maintaining an estimate of the current scene intensity and detecting and/or transmitting change information associated with an event whenever an abrupt or meaningful change is detected, a SPAD can emulate existing event cameras. Specifically, an exponential moving average (EMA) can be maintained, Σ_{EMA}(x, t), updated with Σ_{EMA}(x, t)=γΣ_{EMA}(x, t−1)+(1−γ)Φ(x, t) (5), where t is the frame index, and γ∈[0,1] is a decay factor. Eqs. (1) and (2) can be applied, replacing Φ with Σ_{EMA}.

The intensity reconstructions can be improved by computing and transmitting an adaptive cumulative exposure instead of a single-bit change polarity. For a SPAD, the integral in Eq. (3) can be replaced with a sum over photos: Σ_{cuml}(x, t)=Σ_{s=T}_{₀}^{t}Φ(x, s) (6). Events can still be detected by applying a threshold to changes in the EMA. This may be called an “adaptive-EMA” event camera.

Per-Pixel Bayesian Change Detector: In this section, a Bayesian change detector, BOCPD, that is tailored to the Bernoulli statistics of photon detections is considered. BOCPD uses a series of forecasters to estimate the likelihood of an abrupt change. At each time step, a new forecaster vₜ is initialized as a recurrence of previous forecasters, and existing forecasters are updated: vₜ=(1−γ)Σₛ₌₁^{t-1}lₛvₛ, vₛ←γlₛvₛ∀ₛ<t (7), where γ∈[0,1] is the sensitivity of the change detector, with larger γ resulting in more frequent detections. lₛ is the predictive likelihood of each forecaster, which we compute by tracking two values per forecaster, αₛ and βₛ, that correspond to the parameters of a Beta prior. For a new forecaster, these values are initialized to 1 each, reflecting a uniform prior. Existing (αₛ, βₛ), ∀ₛ<t, are updated as αₛ←αₛ+Φ(, t), βₛ←βₛ+1−Φ(, t) (2). lₛ is given by αₛ/(αₛ+βₛ) if Φ(, t)=1, and βₛ/(αₛ+βₛ) otherwise. An event is triggered if the highest-value forecaster does not correspond to T₀, the timestamp of the last event; mathematically, if argmaxₜ vₜ=T₀.

To make BOCPD more efficient in memory-constrained scenarios, in some examples extreme pruning can be applied by retaining only the three highest-value forecasters. Restarts can also be incorporated by deleting previous forecasters when a change is detected. Compared to an EMA-based change detector, the Bayesian approach may more reliably trigger events in response to scene changes while better filtering out stochastic variations caused by photon noise, such as photon noise 1002 shown in FIG. 10.

Spatiotemporal Chunk Events: As an alternative or addition to the above, a spatiotemporal chunk approach was also tested, given certain advantages. For example, it may be difficult to derive efficient Bayesian change detectors for multivariate time series; thus, a model-free approach has been adopted that does not explicitly parameterize the patch distribution. To afford computational breathing room for more expensive patch-wise operations, temporal chunking is employed. That is, Φ(,t) is averaged over a small number of binary frames (e.g., 32) instead of operating on individual binary frames; generally, this averaging does not induce perceptible blur.

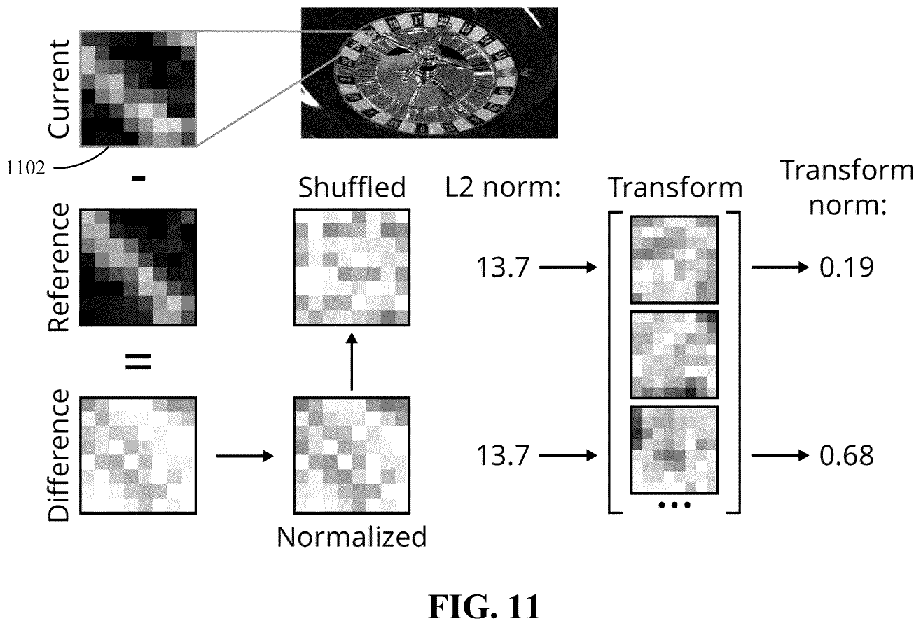

Let vector Φ_{chunk}(, t) represent the chunk-wise average of photon detections at patch location. Let vector Σ_{patch}(, t) be an integrator representing the cumulative mean since the last event, but excluding Φ_{chunk}. It can be estimated whether Φ_{chunk} belongs to the same distribution as Σ_{patch}. This is performed using a lightweight approach, that computes the distance between Φ_{chunk} and Σ_{patch} in the linear feature space of matrix P. As shown in FIG. 11, linear features allow the capture spatial structure to be captured within a patch 1102. Geometrically, P induces a hyperellipsoidal decision boundary, in contrast to the spherical boundary of the L2 norm.

This method generates an event whenever ∥(Φ_{chunk}(y, t)−Σ_{patch}(y, t))Øc(y, t)∥₂≥τ (9), where τ is the threshold and c(y, t) is used for per-pixel normalization (Hadamard division Ø) based on the estimated variance in Φ_{chunk}−Σ_{patch}. The value of c at pixel location x is given by

$$c ( x , t ) = \sqrt{\hat{p} ( x , t ) ( 1 - \hat{p} ( x , t ) ) \frac{1}{m} ( 1 + \frac{1}{n} )} , \qquad ( 10 )$$

$$\hat{p} ( x , t ) = \frac{n {\sum }_{patch} ( x , t ) + {Φ}_{chunk} ( x , t )}{n + 1} , \qquad ( 11 )$$

where n is the number of chunks comprising Σ_{patch} and m is the temporal chunk size. When there is no event, the cumulative mean us extended to include the current chunk. Before computing linear features, we Φ_{chunk} and Σ_{patch} are normalized element-wise according to the estimated variance in Φ_{chunk}−Σ_{patch}; the normalized versions are annotated with a tilde. The variance are estimated based on the fact that, in a static patch, the elements of Φ_{chunk} and Σ_{patch} are independent binomial random variables.

More general norms can be employed in Eq. (9), e.g., L2 norm in a linear transform space, parameterized by matrix P. The matrix P on can be trained on simulated SPAD data, generated from interpolated high-speed video. Backpropagation can be applied through time to minimize the MSE error of the transmitted patch values. To address non-differentiability arising from the threshold, surrogate gradients were employed.

Coded-Exposure Events: An embodiment of a generalized event camera may be designed by applying change detection to coded exposures, which capture temporal variations by multiplexing photon detections over an integration window. Event streams are designed based on an imaging modality not typically associated with event cameras. High-speed information can be obtained even when the change detector operates at a coarser time granularity. Coded-exposure events provide somewhat lower fidelity than the Saptiotemporal Chunk Events and Per-Pixel Bayesian Change Detector designs, but are more compute- and power-efficient, owing to less frequent execution of the change detector.

At each pixel, a temporal chunk of T_{code} (256-512) binary values are multiplexed with a set of J (2-6) codes C^{j}(, t)∀1≤j≤J, producing/coded exposures, where Σ_{coded}^{j}(, t)=Σ_{s=t-T}_{_{code}}^{t}Φ(x, s)C^{j}(x, s) (12). The codes C^{j} are chosen to be random, mutually orthogonal binary masks, each containing T_{code}/max(2,J) ones.

The statistics of coded exposures can be exploited to formulate a change detector. Observe that in static regions, Σ_{coded}^{j}(, t) are iid binomial r.v.'s. Thus, it can be expected that they lie within a binomial confidence interval of one another. If not, it can be assumed that the pixel is dynamic and generate an event. Specifically, an event is triggered if Σ_{coded}^{j}∉conf(n, \hat{p}) for any j. “conf” is a binomial confidence interval (, Wilson's score), n=T_{code}/J draws, and \hat{p}=ΣₛΦ(, s)/T_{code} is the empirical success probability.

If a pixel is static, the sum of the J coded exposures is stored (a long exposure, denoted by Σ_{long}). If the pixel remains static across more than one temporal chunk, Σ_{long} is extended to include the entire duration. Whereas, if the pixel is dynamic, Σ_{coded}^{j} is transmitted, as well as any previous static intensity encoded in Σ_{long}. Downstream, coded-exposure restoration techniques can be applied to recover intensity frames from the coded measurements.

Experimental Results: Certain capabilities of generalized event cameras were demonstrated in testing done by the inventors using a SwissSPAD2 array with resolution 512×256, which was used to capture one-bit frames at 96.8 kHz. The feasibility of the designs are shown on UltraPhase, a recent single-photon computational platform.

For each of the event cameras, a refinement model was trained that mitigates artifacts arising from the asynchronous nature of events. This model takes a periodic frame-based sampling of integrator values and outputs a video reconstruction. The sampling rate is configurable; in practice, we set it 16-64×lower than the SPAD rate. A densely-connected residual architecture was used, trained on data generated by simulating photon detections on temporally interpolated high-speed videos from the XVFI dataset.

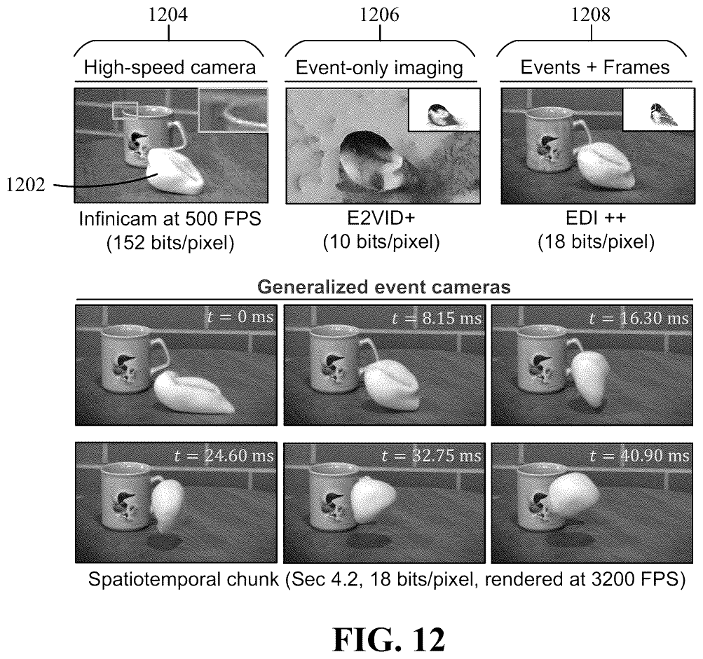

Extreme Bandwidth-Efficient Videography: Shown in FIG. 12, the dynamics of a deformable ball 1202 (a “stress ball”) were captured using a SPAD, a high-speed camera operated at 500 FPS, and a commercial event camera. The high-speed camera suffers from low SNR due to read noise (frame 1204), which manifests as prominent artifacts after on-camera compression. Meanwhile, conventional events captured by the commercial event camera (frame 1206), when processed by “intensity-from-events” methods such as E2VID+ fail to recover intensities reliably, especially in static regions. EDI, a hybrid event-frame method, was also evaluated. An idealized variant is considered that operates on SPAD events (obtained via EMA thresholding), which gives perfect event-frame alignment and a precisely known event-generation model. The outputs of EDI are refined using the same model as for these methods. This idealized, refined version of EDI is referred to as “EDI++” (frame 1208). While EDI++ recovers more detail than other baselines, there are considerable artifacts in its outputs.

The example method achieves high-quality reconstructions at 3025 FPS (96800/32) that faithfully capture non-rigid deformations, with only 431 bits per second per pixel (bps/pixel) readout, which is a 227×compression (96800/431) of the raw SPAD capture. Viewed differently, for a 1 MPixel array, we would obtain a bitrate of 431 Mbps, implying that one can read off these 3025 FPS reconstructions over USB 2.0 (which supports up to 480 Mbps).

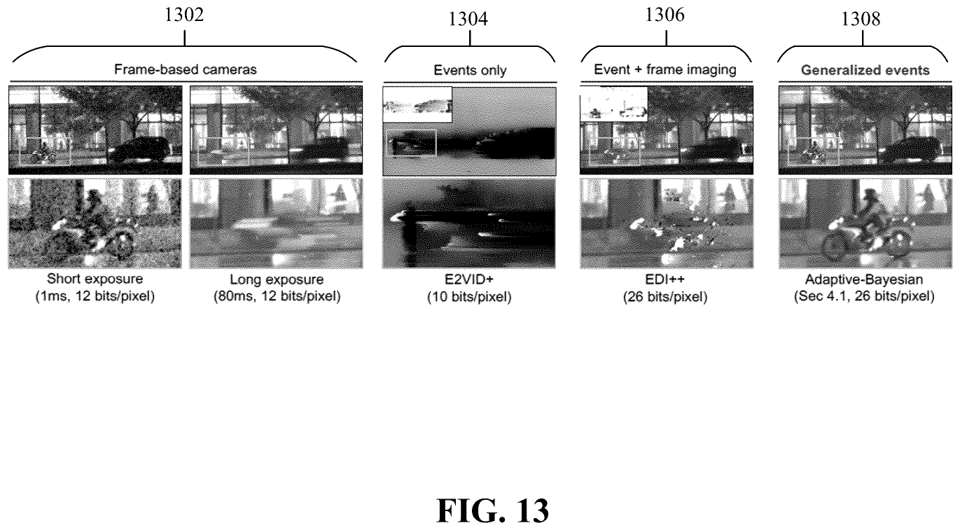

FIG. 13 compares the low-light performance of frame-based, event-based, and a generalized event camera on an urban night-time scene at 7 lux (lux measured at the sensor). For frame-based cameras (frames 1302), a short exposure that preserves motion may be too noisy, while a long exposure can be severely blurred. The commercial event camera's performance (frames 1304) deteriorates in low light, resulting in blurred temporal gradients. EDI++ (frames 1306), benefiting from the idealized SPAD-based implementation, can image this scene, but finer details like the motorcyclist are lost. The generalized event cameras (frames 1308), on the other hand, provide reconstructions with minimal noise, blur, or artifacts—while retaining the bandwidth efficiency of event-based systems. The compression here is 307×with respect to raw SPAD outputs.

Plug-and-Play Interference: Embodiments of generalized event cameras preserve scene intensity, which enables plug-and-play event-based vision. A tennis sequence is considered (of 8196 binary frames), containing a range of object speeds. A range of tasks are evaluated: pose estimation (HRNet), corner detection, optical flow (RAFT), object detection (DETR), and segmentation (SAM). A comparison is performed against event-based methods applied to commercial event camera's events; Arc* is used for corner detection and E-RAFT is used for optical flow. For the remaining tasks, which do not have equivalent event methods, HRNet, DETR, and SAM are run on E2VID+ reconstructions.

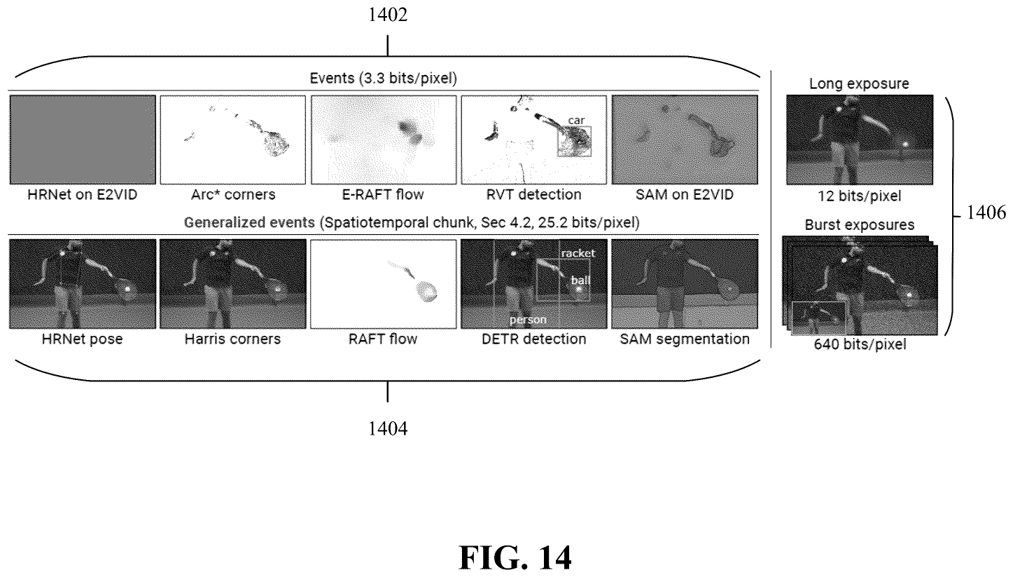

As frames 1402 in FIG. 14 show, traditional events are bandwidth efficient (331 bps/pixel), but do not provide sufficient information for successful inference. Generalized events, shown by frames 1404, have a modestly higher readout (520 bps/pixel), but support accurate inference without requiring dedicated algorithms. To provide context for these rates, a comparison is performed against frame-based methods in frames 1406. A long exposure (120 bps/pixel) blurs out the racket. Burst methods recover a sharp image from a stack of short exposures, but with a large readout of 15100 bps/pixel.

Rate-Distortion Analysis: In this subsection, an evaluation of the impact of readout on image quality (PSNR) is described, based on testing that involved performing a rate-distortion analysis. For ground truth, a set of YouTube-sourced high-speed videos captured by a Phantom Flex4k at 1000 FPS is used. These videos are upsampled to the SPAD's frame rate, and then simulated at 2048 binary frames using the image formation model, described by Eq. (4). When computing readout for each method, it can be assumed that events encode 10-bit values and account for the header bits of each event packet.

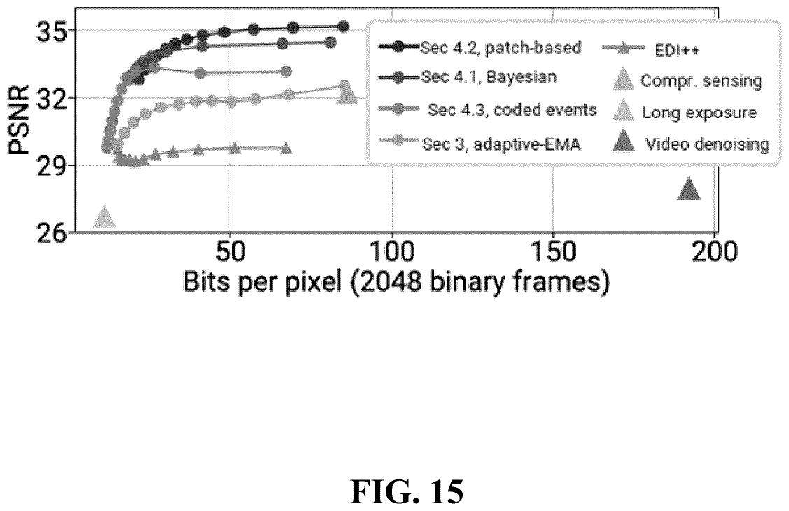

As baselines, EDI++, a long exposure, can be considered compressive sensing with 8-bucket masks, and burst denoising using 32 short exposures. As FIG. 15 shows, generalized event cameras provide a pronounced 3-6 dB PSNR improvement over baseline methods. Further, the methods described herein can compress the raw SPAD response by around 60× before a noticeable drop-off in PSNR is observed.

Among the methods described herein, the inventors found that the spatiotemporal chunk approach gave the best PSNR in many tests, followed by the Bayesian method and the coded-exposure events method. That said, the inventors' testing showed that all methods could achieve fairly similar results in terms of rate-distortion (e.g., all three give comparable results for the scenes), given similar test patterns. The various change detection methods contemplated herein, however, are more distinguishable by their practical characteristics. The Bayesian method gives single-photon temporal resolution; however, as discussed above, it is the most expensive to compute on-chip. The chunk-based method occupies a middle ground in terms of latency and cost. Coded-exposure events have the highest latency—events are generated only every 256-512 binary frames—but the lowest on-chip cost. This provides an end user the flexibility to choose from the space of generalized event cameras based on the latency requirements and the compute constraints of the target application.

On-Chip Feasibility and Validation: Current single-photon sensors have specific bandwidth capabilities and power costs involved in reading off raw photon detections. However, the lightweight nature of the various systems and methods described herein allow these limitations to be sidestepped in a variety of ways, such as by limiting the amount of data that is stored or transmitted on a per-frame basis, by allowing for performance of certain computations on-chip, etc. In tests performed by the inventors, this was demonstrated on an UltraPhase, a SPAD compute platform. UltraPhase utilizes 3×6 compute cores, each of which is associated with 4×4 pixels.

The examples and testing described herein were implemented by the inventors in one embodiment for UltraPhase using custom assembly code. Of course, some methods may require minor modifications due to instruction-set limitations and other idiosyncracies of the platform being used. In the inventors' testing, 2500 SPAD frames were processed from the tennis sequence and cropped to the UltraPhase array size of 12×24 pixels. The number of cycles required to execute the assembly code was determined and the chip's power consumption and readout bandwidth is estimated.

The example methods run comfortably within the chip's compute budget of 4202 cycles per binary frame and its memory limit of 4 Kibit per core. Compared to raw photon-detection readout, the techniques described herein give reductions in bandwidth and power of two and three orders of magnitude, respectively. The coded-exposure method is particularly efficient; on most binary frames, it only requires multiplying a binary code with incident photon detections.

The invention described herein may also comprise additional non-limiting examples of various embodiments, implementations, techniques, and advantages. For example, the generalized event camera may be implemented within a drone, a cellphone, a security camera, a vehicle, etc. Moreover, the generalized event camera may be implemented in various industries such as aerospace, automotive, security, entertainment, medical devices, machine learning, education, and communication, among others.

What is claimed is:

1. A method for detecting changes via an event camera, the method comprising:
monitoring a plurality of pixel measurements from an image sensor with a high frame rate;
determining an estimate of intensity for a scene using a current frame;
detecting changes of the plurality of pixel measurements using the estimate of intensity for the scene;
maintaining a plurality of stored flux values for each of a first plurality of pixels, wherein the first plurality of pixels has not changed intensities;
transmitting change information for each of a second plurality of pixels, wherein the second plurality of pixels have changed intensities; and
determining if a change in the scene has occurred based on the change information for each of the second plurality of pixels.

2. The method of claim 1, further comprising triggering an event in response to determining if the change in the scene has occurred.

3. The method of claim 1, further comprising rendering an event camera image in response to determining if the change in the scene has occurred.

4. The method of claim 1, wherein detecting changes of the plurality of pixel measurements using the estimate of intensity for the scene comprises:
obtaining an average flux intensity for the scene;
determining a threshold value based on the average flux intensity;
monitoring a current flux intensity for the scene;
updating the average flux intensity using the current flux intensity; and
comparing the current flux intensity to the threshold value.

5. The method of claim 1, wherein detecting changes of the plurality of pixel measurements using the estimate of intensity for the scene comprises:
obtaining a plurality of forecasters;
determining an estimate of a likelihood of an abrupt change occurring on the scene;
assigning a value to a forecaster in the plurality of forecasters;
comparing the forecaster to a timestamp of a previous event;
retaining a plurality of values corresponding to a plurality of top forecasters from the plurality of forecasters; and
deleting a remainder of values from the plurality of forecasters.

6. The method of claim 1, wherein detecting changes of the plurality of pixel measurements using the estimate of intensity for the scene comprises:
obtaining an average flux intensity for the scene;
forming a plurality of groups of advancement pixels;
monitoring a plurality of flux intensities corresponding to each of the plurality of groups of advancement pixels;
comparing the plurality of flux intensities to the average flux intensity; and
updating the average flux intensity using the plurality of flux intensities.

7. The method of claim 1, wherein detecting changes of the plurality of pixel measurements using the estimate of intensity for the scene comprises:
obtaining a third plurality of pixels;
multiplexing a temporal chunk of binary values at each of the third plurality of pixels to form a plurality of buckets;
monitoring a plurality of binary values corresponding to each of the plurality of buckets;
determining a plurality of dynamic buckets from the plurality of buckets; and
transmitting the plurality of dynamic buckets.

8. The method of claim 1, wherein the image sensor with the high frame rate is a single photon avalanche diode (SPAD) sensor array of a camera; and wherein the high frame rate results in incoming data that exceeds a readout bandwidth of the camera.

9. The method of claim 1, wherein determining the estimate of intensity for the scene using the current frame also uses an estimate of flux at locations corresponding to each of the plurality of pixel measurements from the image sensor.

10. The method of claim 1, further comprising rendering an optical image of the scene if the change in the scene has occurred, wherein the image corresponds to a time of the change, and wherein the optical image comprises a third plurality of pixels corresponding to cumulative adaptive exposures.

11. A system for detecting changes, the system comprising:
an image sensor;
a processor electrically coupled to the image sensor, the processor programmed to:
monitor a plurality of pixel measurements from the image sensor;
determine an estimate of intensity for a scene using a current frame;
detect changes of the plurality of pixel measurements using the estimate of intensity for the scene;
maintain a stored flux value for each of a first plurality of pixels, wherein the first plurality of pixels has not changed intensities;
transmit an intensity change value for each of a second plurality of pixels, wherein the second plurality of pixels have changed intensities;
determine if a change in the scene has occurred based on the intensity change value for each of the second plurality of pixels; and
trigger an event in response to the change in the scene.

12. The system of claim 11, wherein the processor is further programmed to render an event camera image on a device.

13. The system of claim 11, wherein the processor is further programmed to:
obtain an average flux intensity for the scene;
determine a threshold value based on the average flux intensity;
monitor a current flux intensity for the scene;
update the average flux intensity using the current flux intensity; and
compare the current flux intensity to the threshold value.

14. The system of claim 11, wherein the processor is further programmed to:
obtain a plurality of forecasters;
determine an estimate of a likelihood of an abrupt change occurring on the scene;
assign a value to a forecaster in the plurality of forecasters;
compare the forecaster to a timestamp of a previous event;
retain a plurality of values corresponding to a plurality of top forecasters from the plurality of forecasters; and
delete a remainder of values from the plurality of forecasters.

15. The system of claim 11, wherein the processor is further programmed to:
obtain an average flux intensity for the scene;
form a plurality of groups of advancement pixels;
monitor a plurality of flux intensities corresponding to each of the plurality of groups of advancement pixels;
compare the plurality of flux intensities to the average flux intensity; and
update the average flux intensity using the plurality of flux intensities.

16. The system of claim 11, wherein the processor is further programmed to:
obtain a third plurality of pixels;
multiplex a temporal chunk of binary values at each of the third plurality of pixels to form a plurality of buckets;
monitor a plurality of binary values corresponding to each of the plurality of buckets;
determine a plurality of dynamic buckets from the plurality of buckets; and
transmit the plurality of dynamic buckets.

17. The system of claim 11, wherein the image sensor is a single photon avalanche diode array.

18. The system of claim 17, wherein the single photon avalanche diode array is an image sensor of a camera; and wherein the camera comprises a high frame rate of incoming data that exceeds a readout bandwidth of the camera.

19. The system of claim 11, wherein determining the estimate of intensity for the scene using the current frame also uses an estimate of flux at locations corresponding to each of the plurality of pixel measurements from the image sensor.

20. The system of claim 11, further comprising rendering an optical image of the scene if the change in the scene has occurred, wherein the image corresponds to a time of the change, and wherein the optical image comprises a third plurality of pixels corresponding to cumulative adaptive exposures.
